(19) United States
(12) Patent Application Publication
(10) Pub. No.: US 2008/0261670 A1
(43) Pub. Date: Oct. 23, 2008

(54) AGRICULTURAL WORKING MACHINE

(76) Inventor: Arne Potthast, Marienmuenster (DE)

Correspondence Address: Striker, Striker & Stenby, 103 East Neck Road, Huntington, NY, 11743, US

(21) Appl. No.: 12/104,859

(22) Filed: Apr. 17, 2008

(30) Foreign Application Priority Data
Apr. 19, 2007 (DE) 10 2007 018 885.6

(51) Int. Cl. A01F 12/40

(52) U.S. Cl. 460/78

(57) ABSTRACT

A forage harvester is provided with intake conveyor mechanisms, which convey the chopped material to a downstream chopping assembly, with an upper discharge chute located downstream of the chopping assembly, and with a conditioning device composed of a rotatably drivable roller assembly located between the chopping assembly and the upper discharge chute, and it is possible to adjust the at least two crop material passages between the conditioning rollers of the conditioning device and the gap width of the at least two passages in such a manner that the gap width of the passage located in the inlet region of the conditioning device is larger than the gap width of a passage located downstream in the material flow direction.

### CROSS-REFERENCE TO A RELATED APPLICATION

The invention described and claimed hereinbelow is also described in German Patent Application DE 10 2007 018 885.6 filed on Apr. 19, 2007. This German Patent Application, subject matter of which is incorporated herein by reference, provides the basis for a claim of priority of invention under 35 U.S.C. 119(a)-(d).

### BACKGROUND OF THE INVENTION

The present invention relates to a forage harvester, the intake conveyor mechanisms of which convey the crop material to a chopping assembly. A conditioning device that has at least two material passages is located downstream of the chopping assembly.

Publication DE 195 49 504 makes known a generic forage harvester, the chopping assembly of which is located downstream of a conditioning device that includes three post-fragmentation rollers. The post-fragmentation rollers are positioned relative to each other such that at least two material passages are formed between their circumferential surfaces, through which the crop material that has been fragmentized by the chopping assembly is guided. To ensure that the post-fragmentation device performs an intensive post-fragmentation of the crop material, all of the post-fragmentation rollers have different circumferential velocities, so that the resultant relative motion between the adjacent post-fragmentation rollers at the particular passage has a rubbing effect on the crop material.

The circumferential velocities of the post-fragmentation rollers are matched to each other such that the lower post-fragmentation roller is operated at the lowest circumferential velocity, while the post-fragmentation roller located on the outlet side rotates with the highest circumferential velocity, and the conditioning roller located at the inlet of the conditioning device has a circumferential velocity that is between the circumferential velocities of the other conditioning rollers. Due to the successive increase in circumferential velocity of the higher conditioning roller, a structure of this type has the advantage that the fragmentation effect is gradually increased. Given that the gap width of the passage is always constant, a design of this type has the problem, in particular, that, at high rates of crop material throughput, material may become jammed in the first passage, since the quantity of crop material that may be conveyed through the constant passage is limited. In addition, at high rates of crop material throughput, there is an abrupt increase in the amount of energy required for fragmentation and in the loads on the fragmentation devices.

To ensure that the particular passage is changeable depending on the crop material throughput, a device was made known in publication DE 195 32 290, the conditioning rollers of which are supported such that they are swivelable against the action of an energy-storing device, such as a compression spring assembly. Depending on the crop material throughput to be handled, the conditioning rollers are swiveled against the action of the energy-storing device by the crop material flow itself that is to be conveyed, thereby ultimately resulting in a larger passage. Given that, with a design of this type, the change in the passage depends exclusively on the ratio of forces being applied by the crop material throughput on the conditioning rollers and the counterforce of the energy-storing device, it is not possible to fragmentize the crop material to the full extent.

### SUMMARY OF THE INVENTION

The object of the present invention, therefore, is to avoid the disadvantages of the related art and, in particular, to provide a conditioning device with which an intended influence on the fragmentation effect may be attained with a moderate energy demand and with moderate loads acting on the conditioning device.

This object is attained according to the present invention.

In keeping with these objects, one feature of the present invention resides, briefly stated, in a forage harvester, comprising a downstream chopping assembly; intake conveyor mechanisms which convey a chopped material to said downstream chopping assembly; an upper discharge chute located downstream of said chopping assembly; a conditioning device composed of a rotatably drivable roller assembly located between said chopping assembly and said upper discharge chute, said conditioning device having conditioning rollers that form at least two passages, said at least two passages having a gap width that is adjusted in such a manner that the gap width of one of said passages located in an inlet region of said conditioning device is larger than a gap width of another of said passages located downstream in a material flow direction.

Given that the gap width of the at least two passages is adjustable in such a manner that the width of the passage located in the inlet region of the conditioning device is larger than the width of a passage located downstream in the direction of material flow, it is ensured that an intended influence on the fragmentation effect may be attained with a moderate energy demand and with moderate loads acting on the conditioning device.

In an advantageous embodiment of the present invention, the particular gap width may be adjusted in a stepped or stepless manner, thereby ensuring that the fragmentation of the crop material flow may be adjusted in a highly flexible manner.

Given that, in an advantageous refinement of the present invention, the widths of the upstream and downstream passages are adjustable in a fixed relationship to each other, it is possible to move the conditioning rollers jointly into various positions, using a single swiveling and/or displacement mechanism.

A method of material fragmentation that is particularly efficient and that is optimally adapted to the specific conditions of the particular crop material to be processed is attained when the gap widths of the passages are adjustable depending on crop material parameters and/or the fragmentation level of the crop material. In this context, it is particularly advantageous when the crop material parameters include the crop material type and/or the moisture content of the crop material, and when the fragmentation level includes the desired length of cut and/or the size of the particles in the crop material flow.

Energy-efficient material conveyance and deflection is attained in an advantageous refinement of the present invention when the conditioning device is positioned in the upper discharge chute in the direction of material flow, between the chopping assembly and a post-accelerating device, and when the conditioning rollers are positioned relative to each other such that the upstream passage is located in the direction of flow of crop material entering the conditioning device, and when the downstream passage is located such that the material flow leaving the conditioning device is delivered in the direction of the inlet gap of the post-accelerating device.

A conditioning device with a simple design that nevertheless performs fragmentation in an efficient manner results when the conditioning device is designed as a three-roller conditioning device, and one conditioning roller is located below and the two other conditioning rollers are located above the crop material flow being conveyed through the passage.

Given that, in an advantageous embodiment of a three-roller conditioner, the conditioning roller located below the crop material flow has the larger roller diameter, and the conditioning roller located above the crop material flow has the same or smaller roller diameter, it is ensured that an acceptable compromise results between the intensity of the material deflection in the conditioning device and the number of passages required.

A further optimization of the material deflection process in the conditioning device may be attained when, in an advantageous embodiment of the present invention, the conditioning device includes conditioning rollers located in pairs, and a passage is formed between the pairs of conditioning rollers.

A fragmentation process that is optimized in terms of energy and load considerations is also obtained when, in an advantageous refinement of the present invention, the conditioning device is designed as a four-roller conditioning device, and at least one conditioning roller is located below and the large number of further conditioning rollers is located above the crop material flow being conveyed through the passage. This is due, in particular, to the fact that, with an embodiment of the conditioning device of this type, a large number of passages may be realized, with the result that the fragmentation effect required at the particular passage is less and may therefore be implemented in a manner that is more favorable in terms of energy. In this context, it is also advantageous when the at least one conditioning roller located below the crop material flow and the large number of conditioning rollers located above the crop material flow form passages between them, the passages having a width that decreases from the inlet region toward the outlet region of the conditioning device.

A high degree of flexibility in terms of adjusting the widths of the various passages results in an advantageous refinement of the present invention in particular when either the conditioning rollers located above the crop material flow or the conditioning rollers located below the crop material flow, or all conditioning rollers are supported such that their positions are changeable.

The fragmentation effect of the conditioning device may also be optimally matched to the conditions of the crop material to be processed by the fact that the gap width of the passage located in the inlet region of the conditioning device is changed by the operator of the forage harvester in order to adjust the coarse fragmentation, and the gap width of the downstream passage(s) is changed by the operator or automatically, in order to adjust the fine fragmentation, depending on the fragmentation level that was sensed. The fragmentation effect may be easily adjusted in this manner in particular when the fragmentation level is ascertained using a detection device in the upper discharge chute.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic side view of a forage harvester with an inventive conditioning device

FIG. 2 shows a detailed view of the inventive conditioning device

FIG. 3 shows further embodiments of the inventive conditioning device

### DESCRIPTION OF THE PREFERRED EMBODIMENTS

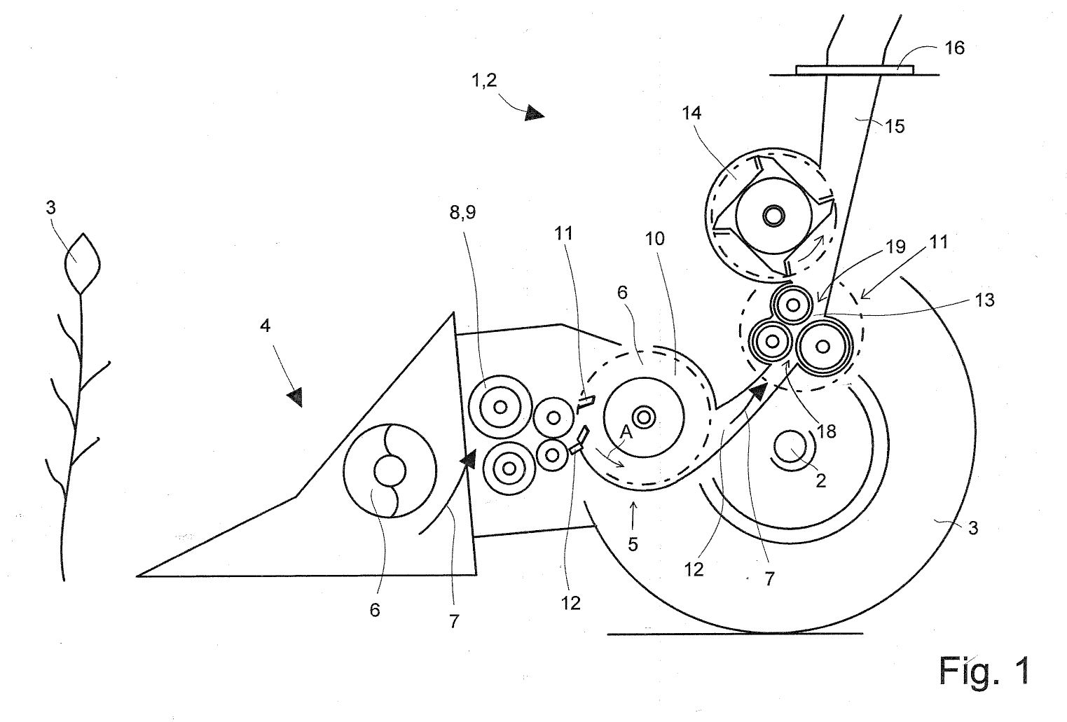

FIG. 1 shows an agricultural working machine 1 designed as self-propelled forage harvester 2, to the front region of which a front attachment 4—which is known per se and will therefore not be discussed in greater detail—is assigned, in order to pick up crop material 3. In a manner known per se, crop material 3 that has been picked up may be combined into a crop material flow 7 using at least one cross auger component and transferred to intake conveyor mechanisms 9—which are provided in pairs and are designed as intake and compression rollers 8—which compress crop material flow 7 and transfer it in their rear region to chopping assembly 10.

Rotating blades 11 of chopping assembly 10—in cooperation with a stationary shear bar 12—fragmentize crop material flow 7 and transfer it—in the rear region of chopping assembly 10—to an inventive conditioning device 13, which will be described in greater detail, e.g., a “corn cracker”. Conditioning device 13 transfers—in its rear region—crop material flow 7 exiting therefrom to a post-accelerator 14, which increases the kinetic energy of crop material flow 7 in such a manner that crop material flow 7 passes through an upper discharge chute 15—which is open at the top—and out of it, thereby enabling crop material flow 7 to be transferred to a not-shown hauling vehicle.

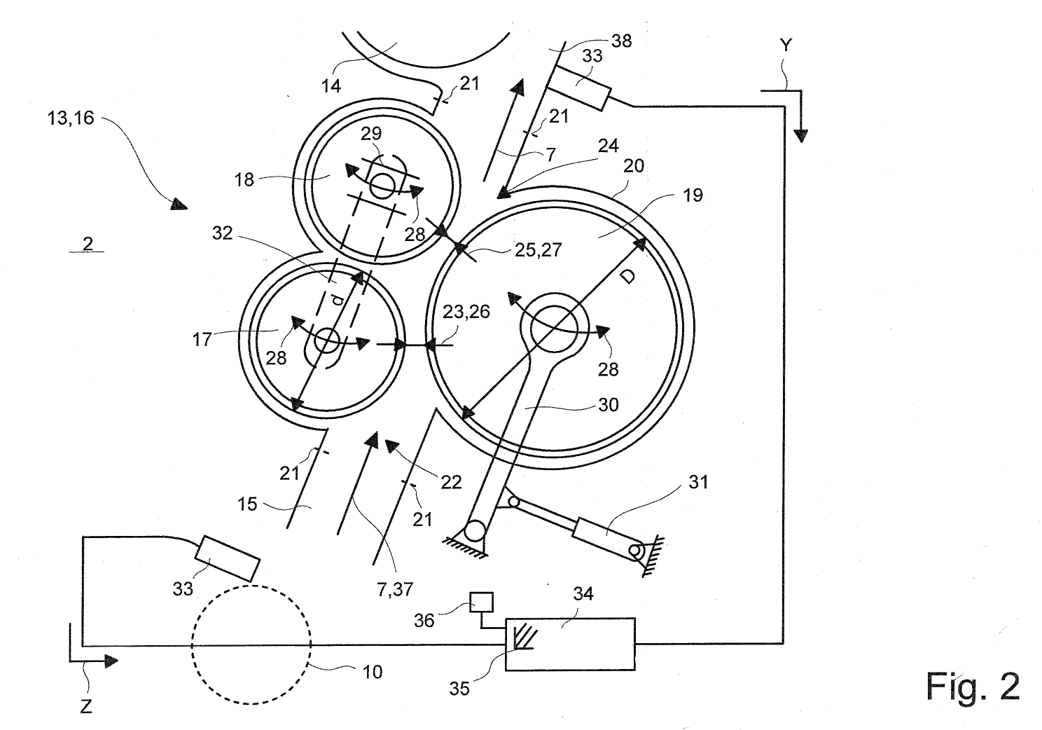

Inventive conditioning device 13 will now be described in detail with reference to FIG. 2. In the exemplary embodiment shown, conditioning device 13 is designed as a three-roller cracker 16. Conditioning rollers 17, 18, 19 of conditioning device 13 are rotatably supported in a roller housing 20, which may be integrated via not-shown connecting means 21 in upper discharge chute 15 in a region between chopping assembly 10 and post-accelerating device 14. Conditioning rollers 17 through 19 include a conditioning roller 19 with a large diameter D, and two further conditioning rollers 17, 18 with a small diameter d. Conditioning rollers 17 through 19 are located in roller housing 20 such that conditioning roller 19 with large diameter D bounds crop material flow 7 passing through conditioning device 13 at the bottom, while the two conditioning rollers 17, 18 with small diameter d bound crop material flow 7 at the top.

This type of configuration of conditioning rollers 17 through 19 relative to each other ensures that a first passage 23 forms between conditioning rollers 17 through 19 in inlet region 22 in the inventive manner, and at least one further passage 25 forms in the outlet region 24 of conditioning device 13. At the same time, conditioning rollers 13 are positioned relative to each other such that gap width 26 of passage 23 located in inlet region 22 is always larger than gap width 27 of passage 25 located in outlet region 24. In this manner, it is ensured that the fragmentation of crop material flow 7 increases gradually, with the result that the fragmentation energy required and the loads to be handled by conditioning device 13 are moderate.

In an advantageous embodiment of the present invention it is provided that conditioning rollers 17 through 19 may change position relative to each other. In this simplest case, this may be brought about by the fact that conditioning rollers 17 through 19 may be displaced or swiveled as indicated by arrow directions 28 depicted schematically in FIG. 2, so that particular gap widths 26, 27 become larger or smaller. Depending on whether conditioning rollers 17 through 19 should be displaced and/or swiveled, conditioning rollers 17 through 19 may be guided in a swiveling manner in not-shown sliding joints 29, and/or using swiveling levers 30.

As a deviation from the depiction shown in FIG. 2 as an example, every conditioning roller 17 through 19 could be guided using swiveling levers 20 or sliding joints 29, in order to change gap width 26, 27 of passage 23, 25. The particular sliding or swiveling motion may be designed such that the position of conditioning rollers 17 through 19 relative to each other may be changed in a stepped or stepless manner. In a simple design, this may be realized, e.g., in that conditioning rollers 17 through 19 may be fixed in defined latching positions, or they may be moved into a desired position steplessly and locked in place there using operating cylinders 31.

Given that, e.g., conditioning rollers 17 through 19 with small diameter d are interconnected via a coupling element 32, and that coupling element 32 is guided in a displaceable or swivelable manner, it may be ensured that, when conditioning rollers 17, 18 change position, gap widths 26, 27 of passages 23, 25 change in a fixed relationship to each other. Given that the operator often wants to change the fragmentation level depending on the material type and its properties, it is also provided that gap widths 26, 27 of passages 23, 25 are changeable depending on crop material parameters, such as the crop material type and/or moisture content of the crop material, and a desired fragmentation level, such as a length of cut or particle size to be attained. In an embodiment having a simple design, this may be attained by providing crop flow detection devices 33—which are known per se, and are not described in greater detail—that may sense the properties of crop material flow 7, such as particle size and moisture content.

Moisture content signals Z and fragmentation signals Y that are generated are transmitted to an evaluation unit 34, in which, in the simplest case, characteristic curves 35 are stored that define optimal gap widths 26, 27 of passages 23, 25 deending on the moisture content or the fragmentation level of crop material flow 7 to be attained. With regard for the fragmentation level, the device may also be designed such that the operator of forage harvester 2 enters a fragmentation level in an input device 36. Evaluation unit 34 then performs a target-versus-actual comparison of the specified fragmentation level with the fragmentation level ascertained by crop flow detection device 33 located downstream of conditioning device 13 and, depending on the result of the comparison, automatically initiates an adjustment of gap widths 26, 27 of passages 23, 25 without the operator of forage harvester 2 being actively involved in this adjustment process.

In a further advantageous embodiment of the present invention, conditioning device 13 is also integrated in upper discharge chute 15 such that passage 23 in its inlet region 22 is located directly in direction of motion 37 of crop material flow 7 entering conditioning device 13, while passage 25 located in outlet region 24 is positioned such that crop material flow 7 being conveyed through it is delivered directly in the direction of inlet gap 38 of post-acceleration device 14.

In the exemplary embodiment described, due to the larger gap width 26 of passage 23 located in inlet region 22 of conditioning device 13, a coarse fragmentation of crop material flow 7 is carried out therein, while smaller gap width 27 of downstream passage 25 results in a fine fragmentation of crop material flow 7. In a further embodiment of the present invention, it may also be provided that gap width 26 of conveying passage 23 is changed by the operator of forage harvester 2 in order to adjust the coarse fragmentation, and gap width 27 of downstream passage 25 is changed by the operator or automatically, in order to adjust the fine fragmentation, depending on the fragmentation level that was sensed.

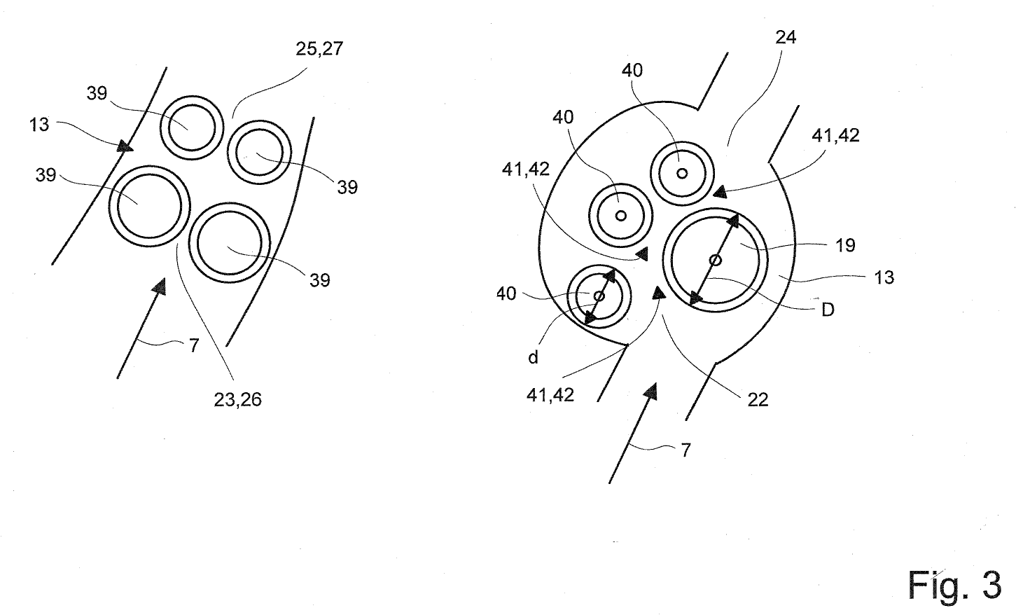

It lies within the scope of the present invention for conditioning device 13 described with reference to FIG. 3 to include conditioning rollers 39 provided in pairs, so that different gap widths 26, 27 of passages 23, 25 described result between the pairs of conditioning rollers 39 in a similar manner. It also lies within the scope of the present invention, according to FIG. 3, for a large number of conditioning rollers 40 with small diameter d to be assigned to a single conditioning roller 19 with large diameter D. A large number of passages 41 may then result that have a gap width 42 that decreases from inlet region 22 toward outlet region 24 in the inventive manner.

It will be understood that each of the elements described above, or two or more together, may also find a useful application in other types of constructions differing from the type described above.

While the invention has been illustrated and described as embodied in an agricultural working machine, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A forage harvester, comprising a downstream chopping assembly; intake conveyor mechanisms which convey a chopped material to said downstream chopping assembly; an upper discharge chute located downstream of said chopping assembly; a conditioning device composed of a rotatably drivable roller assembly located between said chopping assembly and said upper discharge chute, said conditioning device having conditioning rollers that form at least two passages, said at least two passages having a gap width that is adjusted in such a manner that the gap width of one of said passages located in an inlet region of said conditioning device is larger than a gap width of another of said passages located downstream in a material flow direction.

2. A forage harvester as defined in claim 1; and further comprising means for adjusting said gap width in a manner selected from the group consisting of a stepped manner and a stepless manner.

3. A forage harvester as defined in claim 1; and further comprising means for adjusting the gap width of said passages in a fixed relationship to each other.

4. A forage harvester as defined in claim 1; and further comprising means of adjusting the gap width of said passages depending on a variable selected from the group consisting of crop material parameters, fragmentation level of a crop material, and both.

5. A forage harvester as defined in claim 4, wherein said means for adjusting the gap width of said passages is configured so that the gap width is adjustable depending on the crop material parameters selected from the group consisting of a crop material type, a moisture content of the crop material, and both.

6. A forage harvester as defined in claim 4, wherein said means for adjusting the gap width of said passages is configured so that the gap width is adjustable depending on the fragmentation level of the crop material selected from the group consisting of a desired length of cut, a size of particles of a crop material flow, and both.

7. A forage harvester as defined in claim 1; and further comprising a post-accelerating device, said conditioning device being positioned in said upper discharge chute in the material flow direction between said chopping assembly and said post-accelerating device, said conditioning rollers of said conditioning device being located relative to each other such that a front one of said passages is located in the material flow direction entering said conditioning device, while a downstream one of said passages is located such that a crop flow exiting said conditioning device is delivered in a direction of an inlet gap of said post-accelerating device.

8. A forage harvester as defined in claim 7, wherein said conditioning device is configured as a three-roller conditioning device, with one of said conditioning rollers being located below and other two of said conditioning rollers being located above the crop material flow being conveyed through said passages.

9. A forage harvester as defined in claim 8, wherein said one conditioning roller located below the crop material flow has a larger roller diameter, while said conditioning rollers located above a crop material flow have a diameter selected from the group consisting of a same roller diameter and a smaller roller diameter.

10. A forage harvester as defined in claim 7, wherein said conditioning rollers of said conditioning device are arranged in pairs, with a passage being formed between said pairs of said conditioning rollers.

11. A forage harvester as defined in claim 7, wherein said conditioning device is configured as a four-roller conditioning device, with at least one of said conditioning rollers being located below and a larger number of other of said conditioning rollers being located above the crop material flow being conveyed though said passage.

12. A forage harvester as defined in claim 11, wherein said at lest one conditional roller located below the crop material flow and said larger number of conditioning rollers located above the crop material flow form the passages between them with a gap width that decreases from an inlet region toward an outlet region of the conditioning device.

13. A forage harvester as defined in claim 11, wherein conditioning rollers selected from the group consisting of said conditioning rollers located above the material flow, the conditioning rollers located below the material flow, and all conditioning rollers are supported such that a position of said rollers is changeable.

14. A forage harvester as defined in claim 1, wherein the gap width of said passage located in said inlet region of said conditioning device is changeable by an operator of the forage harvester in order to adjust a coarse fragmentation while the gap width of said downstream passage is changeable by an operator or automatically in order to adjust a fine fragmentation, depending on a fragmentation level that was sensed.

15. A forage harvester as defined in claim 14; and further comprising a detection device for ascertaining the fragmentation level and located in said upper discharge chute.
